(19) United States
(12) Patent Application Publication
(10) Pub. No.: US 2015/0144199 A1
(43) Pub. Date: May 28, 2015

(54) DYE-SENSITIZED SOLAR CELL HAVING CARBON NANO-WEB COATED WITH GRAPHENE AND METHOD FOR MANUFACTURING SAME

(71) Applicant: KOREA INSTITUTE OF INDUSTRIAL TECHNOLOGY, Cheonan-si (KR)

(72) Inventors: Hoon Huh, Seoul (KR); Hui Jin Kim, Cheonan-si (KR); Jee Young Jang, Bucheon-si (KR)

(21) Appl. No.: 14/403,725

(22) PCT Filed: May 23, 2013
(86) PCT No.: PCT/KR2013/004511

§ 371 Date: Nov. 25, 2014

(30) Foreign Application Priority Data
May 25, 2012 (KR) 10-2012-0055885
May 23, 2013 (KR) 10-2013-0058073

(51) Int. Cl. H01G 9/20

(52) U.S. Cl. CPC H01G 9/2045; H01G 9/2027; H01G 9/2031; H01G 9/204
USPC 136/263; 438/85

(57) ABSTRACT

A dye-sensitized solar cell and a method for manufacturing same are disclosed. The dye-sensitized solar cell includes: a transparent substrate; a working electrode including a dye-adsorbed metallic oxide disposed on the transparent substrate; a separation film disposed on the working electrode; an electrolyte disposed on the separation film; and an opposite electrode disposed on the electrolyte. A carbon nano-web coated with graphene is disposed between the working electrode and the separation film.

### TECHNICAL FIELD

The present invention relates to a dye-sensitized solar cell which includes a carbon nanoweb coated with graphene in order that a non-conductive substrate may be used instead of a transparent conductive substrate, such as transparent conducting oxide (TCO), and the efficiency of the cell may be improved, and a method of manufacturing the dye-sensitized solar cell.

### BACKGROUND ART

Serious climate warming has been generated due to the emission of air pollutants and greenhouse effect, and global consensus about the climate change crisis has been made. Also, in line with the recent increase in oil price, the diversification policy for the current energy sources is required and the securing of inexpensive and stable energy resources is required.

Thus, interest in and research into renewable energies, such as solar energy, wind energy, and hydroelectric energy, have been rapidly increased, and with respect to a solar cell using the solar energy among the renewable energies, since there is no burden of environmental pollution and infinite energy can be supplied, the interest has been focused on the solar cell.

Solar cells may be categorized as an inorganic solar cell formed of an inorganic material, such as silicon and compound semiconductors, and an organic solar cell mainly formed of an organic material, according to a material constituting the solar cell.

Also, according to market conditions and technology developments, solar cells may be classified into the first-generation crystalline silicon solar cells, the second-generation thin film solar cells, ultra-high efficient solar cells, and the third-generation advanced solar cells.

Among the above solar cells, a dye-sensitized solar cell uses an organic material (dye), and, different from the principle of a typical semiconductor-junction solar cell, the dye-sensitized solar cell uses a principle in which a semiconductor oxide electrode having dye molecules chemically adsorbed thereto is irradiated with light to form excitons and electrons among the excitons are injected into a conduction band of the semiconductor oxide to generate a current.

Since the price of a dye-sensitized solar cell is lower than that of a typical silicon solar cell, price competitiveness of the dye-sensitized solar cell is excellent. Also, since the dye-sensitized solar cell may be variously implemented while being transparent, it is a technique in which its applicability is expected.

A dye-sensitized solar cell has a sandwich structure of a transparent substrate. The cell is composed of a transparent electrode coated on the transparent substrate, porous TiO₂ composed of nanoparticles which is adhered to the transparent electrode, a dye coated in a monolayer on the surface of the TiO₂ particles, an electrolyte solution for oxidation/reduction filling a space between two electrodes, and a counter electrode for reducing an electrolyte.

One of main reasons for being able to rapidly increase the efficiency of the dye-sensitized solar cell is in the increase of the surface area of a semiconductor oxide such as TiO₂. As a result, the efficiency of the cell is improved as TiO₂ particles are smaller and porosity is higher. In general, TiO₂ particles having a diameter of 15 nm to 30 nm are mainly used. A thickness is in a range of 2 μm to 30 μm, wherein the optimum thickness is determined according to the type of the dye.

The dye-sensitized solar cell has advantages in that it is lightweight, has high optical transmittance as well as price competitiveness, and may be used in various applications. However, the dye-sensitized solar cell has still not been commercialized because of disadvantages in that its efficiency is low and its stability is still insufficient. Thus, research into the improvement of the efficiency and lifetime of the cell as well as the modification in terms of materials, such as an electrode substrate, TiO₂, and an electrolyte, has been continued.

Korean Patent No. 10-1127910 mentions that electrical conductivity and transmittance of an electrode may be improved by forming a coating layer, which is formed of at least one of silver (Ag), copper (Cu), and carbon nanotubes, on a transparent conductive substrate formed of gallium-doped zinc oxide.

Korean Patent Application Laid-Open Publication No. 2011-0082864 discloses that the efficiency of a dye-sensitized solar cell may be improved by coating the surface of TiO₂ nanoparticles with ZnO and then integrally growing ZnO nanorods on the surface of the ZnO.

Korean Patent No. 10-1070774 mentions that a dye-sensitized solar cell having excellent stability, mass productivity, and photoelectric conversion efficiency may be provided by utilizing a nanogel-type electrolyte for a dye-sensitized solar cell including nanosilica powder combined with silyl propyl methacrylate and a liquid electrolyte.

As a substrate for an electrode suggested in the above patents, a conductive substrate, such as indium tin oxide (ITO) or fluorine-doped tin oxide (FTO), is used. However, in order to deposit an ITO or FTO thin film on a glass substrate, an expensive apparatus, such as a large sputter, is required to increase manufacturing costs, and a sintering process is required during the manufacturing process. Also, since the material itself is expensive, it may be a cause for increasing the manufacturing price of a solar cell.

### DISCLOSURE OF THE INVENTION

### Technical Problem

As a result of diverse research conducted on a dye-sensitized solar cell having more environmentally friendly and lower cost characteristics than a typical solar cell, the present inventors confirmed that a graphene-carbon nanoweb composite material was used as a battery component so as to use an inexpensive non-conductive substrate, such as a glass or flexible substrate, instead of a transparent conductive substrate, such as indium tin oxide (ITO) or fluorine-doped tin oxide (FTO), and a working electrode based on a metal oxide was formed on the composite material so that physical and chemical stability of the metal oxide may be increased, there was no decrease in cell efficiency due to excellent interfacial characteristics between the composite material and the working electrode even if the non-conductive substrate was used, and the applicability of the flexible substrate may be increased, thereby leading to the completion of the present invention.

The present invention provides a dye-sensitized solar cell, in which the manufacturing price of the cell may be reduced and the efficiency of the cell may be improved, and a method of manufacturing the same.

### Technical Solution

According to an aspect of the present invention, there is provided a dye-sensitized solar cell including:

a transparent substrate;

a working electrode including a dye-adsorbed metal oxide and disposed on the transparent substrate;

a separator disposed on the working electrode;

an electrolyte disposed on the separator; and

a counter electrode disposed on the electrolyte,

wherein a graphene-coated carbon nanoweb is disposed between the working electrode and the separator.

In this case, the surface and inside of the metal oxide of the working electrode may be coated with graphene.

According to another aspect of the present invention, there is provided a method of manufacturing a dye-sensitized solar cell including:

respectively preparing a transparent substrate, a separator, an electrolyte, and a counter electrode;

coating a carbon nanoweb with graphene to prepare a graphene-coated carbon nanoweb;

sintering after coating a metal oxide on the graphene-coated carbon nanoweb;

forming a working electrode on the graphene-coated carbon nanoweb by adsorbing a dye to the sintered metal oxide;

assembling by stacking in sequence of the substrate, the working electrode, the graphene-coated carbon nanoweb, the separator, the electrolyte, and the counter electrode; and

sealing.

In this case, the graphene-coated carbon nanoweb is prepared by:

preparing an ultrafine fiber web by a spinning process using a spinning solution including a carbon precursor and carbonizing the ultrafine fiber web to prepare a carbon nanoweb; and

coating the carbon nanoweb with graphene.

### Advantageous Effects

Since a dye-sensitized solar cell according to the present invention includes a graphene-coated carbon nanoweb as a cell component, a non-conductive substrate, such as a glass or flexible substrate, which is relatively less expensive than a typical expensive transparent conductive substrate, such as indium tin oxide (ITO) or fluorine-doped tin oxide (FTO), may be used. Thus, manufacturing costs of the dye-sensitized solar cell may be reduced.

Also, since a working electrode is formed by directly coating on a graphene-coated carbon nanoweb and sintering, there is no need to perform a direct sintering process on the substrate even if a flexible substrate is used. Thus, the applicability of the flexible substrate may be increased, in which the use thereof has been limited due to a typical sintering process.

Furthermore, physical and chemical stability of a metal oxide used in the working electrode may not only be improved due to three-dimensional structural characteristics and flexibility of the carbon nanoweb, but satisfactory cell efficiency may also be obtained by having excellent interfacial characteristics between the working electrode and the carbon nanoweb.

### BRIEF DESCRIPTION OF THE DRAWINGS

FIG. 1 is a cross-sectional view illustrating a dye-sensitized solar cell according to the present invention; and

FIG. 2 is a graph illustrating a photocurrent-voltage curve of a dye-sensitized solar cell manufactured in Example 2.

### MODE FOR CARRYING OUT THE INVENTION

With respect to a typical solar cell using an expensive transparent conductive substrate, such as indium tin oxide (ITO) or fluorine-doped tin oxide (FTO), there have been limitations such as high price, the limited use of a substrate, and structural problems. In the present invention, provided is a dye-sensitized solar cell having a novel structure in which a carbon nanoweb coated with graphene as well as an inexpensive non-conductive substrate is introduced to be in contact with a working electrode.

Hereinafter, preferred embodiments of the present invention will be described with reference to the accompanying drawings. In adding reference numerals to elements throughout the drawings, it is to be noted that like reference numerals refer to like elements even though elements are shown in different drawings, and detailed descriptions related to well-known functions or configurations will be ruled out in order not to unnecessarily obscure subject matters of the present invention. Also, the present invention will be more fully described according to specific embodiments. However, the embodiments are merely presented to exemplify the present invention, and the scope of the present invention is not limited thereto.

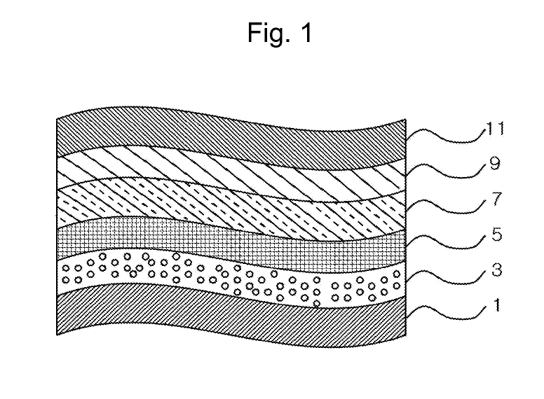

FIG. 1 is a cross-sectional view illustrating a dye-sensitized solar cell according to the present invention. In this case, various layers known in the art may be inserted between layers.

Referring to FIG. 1, the dye-sensitized solar cell includes a transparent substrate 1, a working electrode 3 including a dye-adsorbed metal oxide and disposed on the transparent substrate 1, a separator 7 disposed on the working electrode 3, an electrolyte 9 disposed on the separator 7, and a counter electrode 11 disposed on the electrolyte 9.

In particular, in the present invention, a non-conductive substrate is used as the transparent substrate 1, and a graphene-coated carbon nanoweb 5 is disposed between the working electrode 3 and the separator 7.

Hereinafter, each component will be described in more detail.

First, different from a typical transparent conductive substrate, the relatively inexpensive non-conductive transparent substrate 1 including transparent conductive oxide (TCO) is used as a substrate.

The transparent substrate 1 acts as a support, and since it is non-conductive, it does not act as an electrode like a transparent conductive substrate such as ITO.

The usable transparent substrate 1 may include one selected form the group consisting of glass, polyethylene terephthalate, polyethylene naphthalate, polycarbonate, polypropylene, polyimide, polyacrylate, polyethylene, polyurethane, epoxy, polyamide, and a combination thereof.

When using a flexible substrate including a resin, such as polyethylene terephthalate, as the transparent substrate 1, there are advantages in which the substrate may be prepared in various forms due to unique flexibility, transparency is higher than that of a typical conductive substrate such as ITO or FTO, and costs may be reduced.

The working electrode 3, as a photoelectrode, light-sensitive electrode, or anode, is disposed on the transparent electrode 1, and includes a metal oxide to which a dye is adsorbed.

The metal oxide and the dye are not particularly limited in the present invention, and metal oxide and dye used in a dye-sensitized solar cell may be used.

As the metal oxide, one selected from the group consisting of titanium oxide, zinc oxide, tin oxide, niobium oxide, tungsten oxide, strontium oxide, zirconium oxide, and a combination thereof may be used, and for example, titanium oxide may be used. Particles having a diameter of a few nanometers to a few hundred microns, for example, 1 nm to 900 μm, may be used as the metal oxide.

The dye is adsorbed between pores of the metal oxide, and in this case, the dye may include a material capable of absorbing visible light including a ruthenium or coumarin dye. In this case, the adsorption of the dye is performed by a method in which the working electrode 3 is immersed in a dye solution or spin-coated with a dye solution.

In addition, electrical conductivity of the working electrode 3 may be further improved by coating the surface and inside of the metal oxide with graphene.

In this case, the coating may be performed by spray coating, dip coating, electrostatic spraying, sputtering, or chemical vapor deposition, and for example, the coating may be performed using an electrostatic spray process, which will be described later, to coat graphene to a thickness of 1 nm to 500 nm on the metal oxide particles. In this case, since an improvement of the movement speed of electrons may not be expected when the coating thickness of the graphene is less than the above range, the coating thickness is appropriately adjusted within the above range.

In particular, in the present invention, the graphene-coated carbon nanoweb 5 is disposed on the working electrode 3 in order to prevent the reduction of cell efficiency even if a non-conductive transparent substrate, instead of ITO, is used as the substrate.

As illustrated in FIG. 1, the graphene-coated carbon nanoweb 5 is disposed between the working electrode 3 and the separator 7, and is disposed to be directly in contact with the working electrode 3. Although it will be later described in detail, the working electrode 3 is formed on the graphene-coated carbon nanoweb 5 instead of the substrate in the present invention, different from the case in which the working electrode 3 including dye-TiO₂ is typically formed on an ITO substrate, and the working electrode 3 is laminated with the transparent substrate 1 by a subsequent process.

As a result, physical and chemical instability generated in an electrode of a typical metal oxide substrate may be eliminated due to three-dimensional structure and flexibility of the carbon nanoweb that is directly in contact with the working electrode 3. Furthermore, the graphene-coated carbon nanoweb 5 is directly in contact with the metal oxide constituting the working electrode 3 and has excellent interfacial characteristics with respect to the metal oxide due to its three-dimensional structure, and as a result, the efficiency of the solar cell may be improved.

In a typical dye-sensitized solar cell, the cell efficiency is reduced due to the recombination of electrons and holes between a metal oxide and an electrolyte. However, the carbon nanoweb may suppress such recombination, and cell performance may be improved because ions of the electrolyte may smoothly move between pores present in the carbon nanoweb.

A thickness of the carbon nanoweb is in a range of 0.1 μm to 10 mm, and may be in a range of 1 μm to 1,000 μm. In this case, a diameter of carbon nanofibers constituting the carbon nanoweb is in a range of 1 nm to 1,000 nm, may be in a range of 10 nm to 500 nm, and for example, may be in a range of 50 nm to 100 nm.

Graphene is coated on the carbon nanoweb, and in this case, graphene having a width of 1 μm to 10 μm may be used.

The surface and inside of the carbon nanoweb are coated with graphene to a thickness of 0.01 μm to 1,000 μm. When the thickness is less than the above range, an effect of improving electrical conductivity may not be expected. In contrast, when the thickness is greater than the above range, the movement of the electrolyte may be difficult. Thus, the thickness is appropriately adjusted within the above range.

A method of manufacturing the graphene used in this case is not limited, and the graphene may be directly manufactured or commercially available flake-type graphene may be directly purchased and used.

The separator 7, the electrolyte 9, and the counter electrode 11 are sequentially disposed on the graphene-coated carbon nanoweb 5. In the present invention, the separator 7, the electrolyte 9, and the counter electrode 11 are not particularly limited, and any separator, electrolyte, and counter electrode may be used so long as they are usable in a dye-sensitized solar cell.

For example, the separator 7 is used to prevent a short circuit between the working electrode 3 and the counter electrode 11, and plays a role as a support. The separator 7, as an ion-permeable membrane, typically has a thickness of 10 μm to 100 μm, and may include one material selected from the group consisting of polyethylene, polypropylene, polyamide, cellulose, polyvinyl chloride, polyvinyl alcohol, polyvinylidene fluoride, and a combination thereof.

In particular, due to the support role of the separator 7, the solar cell may be manufactured to have a large area, damage may be prevented by increasing robustness, and a displacement phenomenon may be prevented when a liquid electrolyte is used as the electrolyte 9.

The electrolyte 9 is not limited in the present invention, and a liquid electrolyte or polymer electrolyte typically used in the art may be used.

For example, a liquid electrolyte, in which dimethyl-hexyl imidazolium iodide, guanidine thiocyanate, iodine, and 4-tert-butyl pyridine are dissolved in an acetonitrile/valeronitrile mixture, may be used as the liquid electrolyte, and examples of the polymer electrolyte may include one selected from the group consisting of polyacrylonitrile (PAN)-based polymers, poly(vinylidene fluoride-co-hexafluoropropylene) (PVdF)-based polymers, acrylic-ionic liquid combination, pyridine-based polymers, polyethylene oxide) (PEO), and a combination thereof.

As the counter electrode 11, a metal layer formed by depositing a conductive material, such as copper (Cu), silver (Ag), gold (Au), platinum (Pt), and nickel (Ni), on a non-conductive substrate, such as a glass or flexible substrate, mentioned as the substrate 1 and a conductive substrate such as ITO and FTO, or a thin metal plate (aluminum and stainless steel) may be used. In this case, the counter electrode 11 is not necessarily transparent.

For example, chloroplatinic acid is coated and then heat-treated to form a Pt thin film on a substrate or a Pt thin film may be formed on a glass substrate by a deposition method or sputtering method.

The dye-sensitized solar cell having the above-described configuration is manufactured by the steps of:

respectively preparing a transparent substrate, a separator, an electrolyte, and a counter electrode;

coating a carbon nanoweb with graphene to prepare a graphene-coated carbon nanoweb;

sintering after coating a metal oxide on the graphene-coated carbon nanoweb;

forming a working electrode on the graphene-coated carbon nanoweb by adsorbing a dye to the sintered metal oxide;

assembling by stacking in sequence of the substrate, the working electrode, the graphene-coated carbon nanoweb, the separator, the electrolyte, and the counter electrode; and

sealing.

Hereinafter, each step will be described in detail.

First, a transparent substrate, a separator, an electrolyte, and a counter electrode are respectively prepared.

Next, a carbon nanoweb is coated with graphene to prepare a graphene-coated carbon nanoweb.

The graphene-coated carbon nanoweb is prepared by coating the carbon nanoweb with the graphene. In this case, the carbon nanoweb and the graphene may be directly manufactured, or commercially available graphene may be purchased and used.

Preferably, the graphene-coated carbon nanoweb is prepared by preparing an ultrafine fiber web by a spinning process using a spinning solution including a carbon precursor and carbonizing the ultrafine fiber web to prepare a carbon nanoweb; and coating the carbon nanoweb with graphene.

The spinning solution includes the carbon precursor capable of forming carbon nanofibers after the carbonization and a solvent capable of dissolving the carbon precursor.

In this case, the carbon precursor may include one selected from the group consisting of polyacrylonitrile (PAN), poly(furfuryl alcohol), cellulose, glucose, polyvinyl chloride, polyacrylic acid, polylactic acid, polyethylene oxide, polypyrrole, polyimide, polyamide-imide, polyaramid, poly benzyl imidazole, polyaniline, a phenol resin, pitches, sucrose, a resorcinol-formaldehyde gel, a melamine-formaldehyde gel, divinylbenzene, polyacetylene, polypropylene, and a combination thereof.

The solvent is not particularly limited in the present invention, and for example, the solvent may include one selected from the group consisting of water, methanol, ethanol, isopropyl alcohol, ethylene glycol, glycerol, perfluorodecalin, perfluoromethyldecalin, perfluorononane, perfluoro iso acid, hexane, perfluorocyclohexane, 1,2-dimethylcyclohexane, dimethylformamide (DMF), toluene, tetrahydrofuran (THF), dimethyl sulfoxide, dimethyl acetamide, N-methyl pyrrolidone (NMP), chloroform, methylene chloride, carbon tetrachloride, trichlorobenzene, benzene, cresol, xylene, acetone, methyl ethyl ketone, acrylonitrile, cyclohexane, cyclohexanone, ethyl ether, and a combination thereof.

In order to facilitate the spinning of the spinning solution, a concentration of the spinning solution is controlled to be in a range of 0.1 wt % to 40 wt %. In this case, if necessary, an additive known in the art may be included.

Any spinning process may be used as the spinning process as long as two-dimensional or three-dimensional pores may be prepared by the spinning process such as electrospinning, electrobrown spinning, centrifugal electrospinning, and flash-electrospinning, and the electrospinning may be performed.

The electrospinning is not particularly limited in the present invention, and the electrospinning may be performed using an electrospinning apparatus known in the art. The electrospinning apparatus is composed of a power supply for applying a voltage, a spinneret, and a collector for collecting fibers.

The inflow of the spinning solution is controlled at a constant rate by a pump and the spinning solution is discharged through a nozzle acting as the spinneret. In this case, one electrode injects charge into the discharged spinning solution by connecting between the power supply and a nozzle tip so that the spinning solution is charged, and an opposite electrode is connected to a collector plate. Before the spinning solution discharged from the nozzle tip is arrived at the collector, both the evaporation of the solvent and drawing are performed together so that an ultrafine fiber web having a nanoscale diameter may be obtained at an upper portion of the collector.

In this case, the form of the obtained ultrafine fiber web may be controlled according to various parameters such as a voltage applied between the spinneret and the collector, a distance therebetween, flow of the spinning solution, a nozzle diameter, and arrangement of the spinneret and the collector.

Preferably, the voltage between the spinneret and the collector is in a range of 5 V to 50 V, may be in a range of 10 V to 40 V, and for example, may be in a range of 15 V to 20 V. The voltage directly affects a diameter of ultrafine fibers constituting the ultrafine fiber web. That is, the diameter of the ultrafine fibers decreases when the voltage increases but the surface of the ultrafine fibers becomes very rough. In contrast, when the voltage is excessively low, the preparation of ultrafine fibers having a nanoscale diameter may be difficult. Thus, the voltage is appropriately adjusted within the above range.

Also, the smaller the diameter of the spinneret is, the smaller the diameter of the ultrafine fibers is. Thus, similar to the voltage, the spinneret having a diameter of 0.005 mm to 0.5 mm is used to prepare ultrafine fibers having a nanoscale diameter and a uniform surface.

The prepared ultrafine fiber web is subjected to a carbonization process to be prepared as a carbon nanoweb.

The carbonization is performed as a process for preparing typical carbon fibers, and is not particularly limited in the present invention. The carbonization process may be performed by performing a heat treatment at a temperature of about 500° C. to about 3,000° C. for 20 minutes to hours. Carbon atoms are rearranged or adhered by the carbonization to prepare a carbon structure having excellent conductivity, i.e., a carbon nanoweb. If the temperature or time is less than the above range, the formation of the carbon nanoweb is difficult.

The coating of the graphene on the carbon nanoweb prepared by the above step may be performed on a top, a bottom, or both sides of the carbon nanoweb. The graphene may be coated on the carbon nanoweb to be in contact with the working electrode.

In this case, the coating of the graphene on the carbon nanoweb may be performed by a wet or dry coating method. For example, a method, such as spray coating, dip coating, electrostatic spraying, sputtering, and chemical vapor deposition, may be used, and the coating may be performed by an electrostatic spray process.

In particular, the coating of the graphene by the electrostatic spraying may be performed using the electrospinning apparatus used during the preparation of the carbon nanoweb. That is, the electrostatic spray process different from the electrospinning may be performed by simply adjusting the voltage during the electrospinning.

Specifically, an electric field is formed by a voltage generator that is connected to a syringe containing a graphene solution, the graphene solution sprayed from the syringe is deposited in a droplet state on the carbon nanoweb by the electric field, and the carbon nanoweb deposited with the graphene solution is then dried. Although it depends on the apparatus, the electrostatic spraying may be performed at a voltage between the spinneret and the collector of 5 V to 50V, preferably, 10 V to 40 V, more preferably, 15 V to 20 V, a flow rate of 0.001 ml/min to 10 ml/min, and a distance between the syringe and the substrate of 1 cm to 15 cm.

A method of manufacturing the graphene used in this case is not limited, and the graphene may be directly manufactured or commercially available flake-type graphene may be directly purchased and used. For example, in the present embodiment, graphene having a width of 2 μm to 3 μm was directly manufactured by a chemical peeling method and used.

The solvent is not particularly limited in the present invention. However, the solvent may have high dispersion stability in order to allow the graphene solution to be maintained without aggregation or agglomeration and precipitation for a long period of time, and various additives, such as a dispersant and a stabilizer, may be used with the known solvent to be able to form stable droplets without clogging the nozzle during the electrostatic spraying. In this case, the graphene solution for spraying is prepared to have a concentration of 0.01 wt % to 40 wt % and used.

Next, a metal oxide is coated on the graphene-coated carbon nanoweb and then sintered.

A type of the metal oxide may include the above-described metal oxides, and the coating is performed by casting a coating solution in which TiO₂ is dissolved in a solvent. In this case, in order for the metal oxide to have nanoscale particles, a coating solution, in which a metal precursor is dissolved, may be used instead of the above coating solution.

The sintering may be changed according to various parameters such as a composition of the coating solution or physical properties of the finally obtained metal oxide. For example, a coating solution including TiO₂, distilled water, and polyethylene glycol is prepared and then cast. A low boiling point component (distilled water) is evaporated near 120° C., a high boiling point component (polyethylene glycol) is evaporated near 250° C., and a process of sintering residual organics at 450° C. in air is then performed.

Next, a working electrode is formed on the graphene-coated carbon nanoweb by performing the step of adsorbing a dye to the sintered metal oxide.

Thereafter, a dye-sensitized solar cell is manufactured by stacking in sequence of the prepared or manufactured substrate, the working electrode, the graphene-coated carbon nanoweb, the separator, the electrolyte, and the counter electrode, assembling, and then sealing.

After the above step, the dye-sensitized solar cell of the present invention has a structure including the transparent substrate 1, the working electrode 3 including a dye-adsorbed metal oxide and disposed on the transparent substrate 1, the separator 7 disposed on the working electrode 3, the electrolyte 9 disposed on the separator 7, and the counter electrode 11 disposed on the electrolyte 9, wherein the graphene-coated carbon nanoweb 5 is disposed between the working electrode 3 and the separator 7.

As a result, since a non-conductive substrate, such as a glass or flexible substrate, which is relatively less expensive than a typical expensive transparent conductive substrate such as ITO or FTO, may be used, manufacturing costs of the dye-sensitized solar cell may be reduced.

Also, since the working electrode is formed by directly coating on the graphene-coated carbon nanoweb and sintering, there is no need to perform a direct sintering process on the substrate even if a flexible substrate is used. Thus, the applicability of the flexible substrate may be increased, in which the use thereof has been limited due to a typical sintering process.

Furthermore, physical and chemical stability of the metal oxide used in the working electrode may not only be improved due to the three-dimensional structural characteristics and flexibility of the carbon nanoweb, but satisfactory cell efficiency may also be obtained by having excellent interfacial characteristics between the working electrode and the carbon nanoweb.

Hereinafter, the present invention will be described in detail, according to specific examples. However, the following examples are merely provided to allow for a clearer understanding of the present invention, rather than to limit the scope of the present invention. Therefore, the true scope of the present invention should be defined by the technical spirit of the appended claims.

### Example 1

### Preparation of Graphene-coated Carbon Nanoweb

A spinning solution was prepared by dissolving polyacrylonitrile (PAN) in dimethylformamide (DMF) at a concentration of 12 wt %, and the spinning solution was then injected into a syringe pump of an electrospinning apparatus and a flow rate was set to be 0.005 ml/h. In this case, a collector and a spinneret were vertically disposed, and the collector was designed as a metal electrode having conductivity and prepared. A distance between the spinneret and the collector was set to be 15 cm, and an ultrafine fiber web formed of ultrafine fibers (diameter of 100 nm to 500 nm) was prepared by applying a voltage of 15 V.

The ultrafine fiber web was put in a furnace, and a carbonization process was performed at 1,000° C. for 3 hours to prepare a carbon nanoweb (diameter of 50 nm to 100 nm).

Subsequently, the prepared carbon nanoweb was coated with graphene (width of 2 μm to 3 μm) by an electrostatic spray process using the electrospinning apparatus. Specifically, a spraying solution was prepared by dispersing graphene in DMF at a concentration of 0.1 wt %, was injected into the syringe pump, and then was sprayed on the carbon nanoweb at a flow rate of 0.005 ml/h by applying a voltage of 20 V. In this case, a distance between the syringe pump and the carbon nanoweb was set to be 15 cm.

### Example 2

### Preparation of Dye-Sensitized Solar Cell

(1) Working Electrode/Graphene-Coated Carbon Nanoweb Preparation

A slurry was prepared by using 0.5 g of TiO₂ (200 nm) and 2 ml of a polyethylene glycol (weight-average molecular weight 20,000, Junsei) aqueous solution (2.5 g/37.5 ml in H₂O).

The slurry was cast on the graphene-coated carbon nanoweb prepared in Example 1 to a thickness of 10 μm, and after putting in a furnace, organics were removed by increasing a temperature from room temperature to 450° C. at a rate of about 5° C./min and sintering for 30 minutes. Then, the temperature was decreased to room temperature at a rate of about 5° C./min to prepare a stack of TiO₂/graphene-coated carbon nanoweb.

Thereafter, the stack was immersed in a dye bath (ruthenium 535 dye solution), in which 20 mg of cis-bis(isothiocyanato)bis(2,2′-bipyridyl-4,4′-dicaboxylato)ruthenium(II) (ruthenium 535 dye, Solaronix SA, Swiss) was dissolved in 100 ml of ethanol, for 24 hours to adsorb the dye to TiO₂. Subsequently, a physically adsorbed dye layer was removed using ethanol, and the dye was then adsorbed by drying at 60° C.

(2) Preparation of Counter Electrode

TCO glass (FTO) was cleaned and coated with a Pt paste (Platisol Pt-catalyst, Solaronix SA, Swiss) using a brush. Then, the counter electrode was prepared by putting the coated TCO glass in an electric crucible and sintering at 400° C. for 20 minutes.

(3) Electrolyte Solution Preparation

An electrolyte solution was prepared by mixing 0.1 mol tetrabutylammonium iodide and 0.3 mol 1-propyl-3-methylimidazolium iodide in a solvent having a volume ratio of ethylene carbonate:propylene carbonate:acetonitrile of 7:2:4 and stirring for 24 hours.

(4) Manufacture of Test Cell

The working electrode/graphene-coated carbon nanoweb, the electrolyte solution, and the counter electrode, which were prepared in (1) to (3), were prepared, a PET substrate was disposed to be in contact with the working electrode, and a PP separator was disposed between the graphene-coated carbon nanoweb and the electrolyte solution. Then, these were bonded together and then sealed to manufacture a dye-sensitized solar cell.

### Experimental Example 1

### Performance Evaluation of Dye-Sensitized Solar Cell

A photocurrent-voltage curve was measured in order to evaluate the performance of the dye-sensitized solar cell manufactured according to the present invention as a cell.

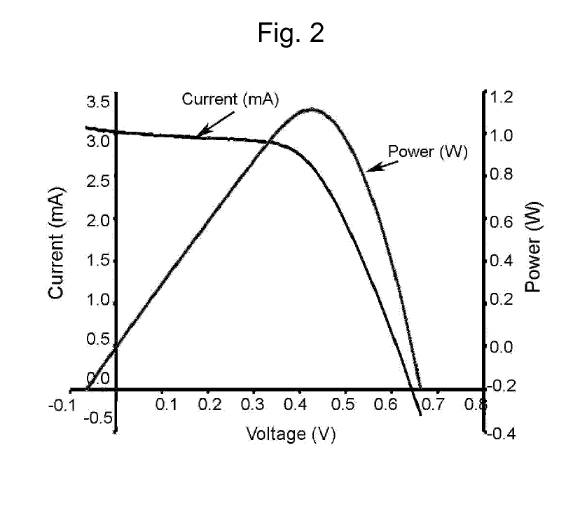

FIG. 2 is a graph illustrating a photocurrent-voltage curve of a dye-sensitized solar cell manufactured in Example 2. Referring to FIG. 2, it may be understood that the dye-sensitized solar cell according to the present invention had excellent cell characteristics.

### INDUSTRIAL APPLICABILITY

The dye-sensitized solar cell according to the present invention may be used in solar energy industry and energy storage industry.

1. A dye-sensitized solar cell comprising:
a transparent substrate;
a working electrode including a dye-adsorbed metal oxide and disposed on the transparent substrate;
a separator disposed on the working electrode;
an electrolyte disposed on the separator; and
a counter electrode disposed on the electrolyte,
wherein a graphene-coated carbon nanoweb is disposed between the working electrode and the separator.

2. The dye-sensitized solar cell of claim 1, wherein the transparent substrate comprises one material selected form the group consisting of glass, polyethylene terephthalate, polyethylene naphthalate, polycarbonate, polypropylene, polyimide, polyacrylate, polyethylene, polyurethane, epoxy, polyamide, and a combination thereof.

3. The dye-sensitized solar cell of claim 1, wherein the metal oxide has a diameter of 1 nm to 900 μm and comprises one selected from the group consisting of titanium oxide, zinc oxide, tin oxide, niobium oxide, tungsten oxide, strontium oxide, zirconium oxide, and a combination thereof.

4. The dye-sensitized solar cell of claim 1, wherein the metal oxide further comprises pores, and inside and outside of the pore are coated with graphene to a thickness of 1 nm to 500 nm.

5. The dye-sensitized solar cell of claim 1, wherein the dye comprises a ruthenium dye or a coumarin dye.

6. The dye-sensitized solar cell of claim 1, wherein the graphene-coated carbon nanoweb is formed by coating a surface and inside of a carbon nanoweb with graphene to a thickness of 0.01 μm to 1,000 μm.

7. The dye-sensitized solar cell of claim 1, wherein a thickness of the carbon nanoweb is in a range of 0.1 μm to 10 mm.

8. The dye-sensitized solar cell of claim 1, wherein, a diameter of carbon nanofibers constituting the carbon nanoweb is in a range of 1 nm to 1,000 nm.

9. The dye-sensitized solar cell of claim 1, wherein a width of the graphene is in a range of 1 μm to 10 μm.

10. The dye-sensitized solar cell of claim 1, wherein the separator has a thickness of 10 μm to 100 μm and comprises one material selected from the group consisting of polyethylene, polypropylene, polyamide, cellulose, polyvinyl chloride, polyvinyl alcohol, polyvinylidene fluoride, and a combination thereof.

11. The dye-sensitized solar cell of claim 1, wherein the electrolyte is a liquid electrolyte or a solid electrolyte.

12. The dye-sensitized solar cell of claim 1, wherein the counter electrode comprises a layer, in which one metal selected from the group consisting of copper (Cu), silver (Ag), gold (Au), platinum (Pt), and nickel (Ni) is coated on a non-conductive substrate or a conductive substrate, or a thin metal plate including aluminum and stainless steel.

13. A method of manufacturing the dye-sensitized solar cell of claim 1, the method comprising:
respectively preparing a transparent substrate, a separator, an electrolyte, and a counter electrode;
coating a carbon nanoweb with graphene to prepare a graphene-coated carbon nanoweb;
sintering after coating a metal oxide on the graphene-coated carbon nanoweb;
forming a working electrode on the graphene-coated carbon nanoweb by adsorbing a dye to the sintered metal oxide;
assembling by stacking in sequence of the substrate, the working electrode, the graphene-coated carbon nanoweb, the separator, the electrolyte, and the counter electrode; and
sealing.

14. The method of claim 13, wherein the graphene-coated carbon nanoweb is prepared by:
preparing an ultrafine fiber web by a spinning process using a spinning solution including a carbon precursor and carbonizing the ultrafine fiber web to prepare a carbon nanoweb; and
coating the carbon nanoweb with graphene.

15. The method of claim 14, wherein the spinning process is performed by electrospinning, electrobrown spinning, centrifugal electrospinning, and flash-electrospinning.

16. The method of claim 14, wherein the coating of the carbon nanoweb with graphene is performed by spray coating, dip coating, electrostatic spraying, sputtering, or chemical vapor deposition.

17. The method of claim 13, wherein the metal oxide having a surface and inside coated with graphene is used.
